(19) United States
(12) Patent Application Publication
(10) Pub. No.: US 2015/0333447 A1
(43) Pub. Date: Nov. 19, 2015

(54) ELECTRICAL CONNECTOR HAVING ANTI-MISMATING MEMBER

(71) Applicant: FOXCONN INTERCONNECT TECHNOLOGY LIMITED, Grand Cayman (KY)

(72) Inventors: MING-GUANG BAI, Kunshan (CN); XIAO WANG, Kunshan (CN); SHU-JIAN WANG, Kunshan (CN); TIE-BING CHEN, Kunshan (CN)

(21) Appl. No.: 14/710,621

(22) Filed: May 13, 2015

(30) Foreign Application Priority Data
May 14, 2014 (CN) 201420243235.9

(51) Int. Cl. H01R 13/64; H01R 12/72; H01R 13/6581

(52) U.S. Cl. CPC H01R 13/64; H01R 13/6581; H01R 12/722

(57) ABSTRACT

An electrical connector includes an insulating housing, a plurality of conductive terminals received in the insulating housing and a metallic shell shielding around the insulating housing. The insulating housing has a base portion and a mating tongue extending forwardly from a front face of the base portion. The metallic shell surrounds the mating tongue to form a mating cavity. The conductive terminals have contacting portions exposed on the mating tongue. The metallic shell has an anti-mismating portion extending forwardly from an area adjacent to the base portion into the mating cavity and located on a lateral side of the mating tongue.

### BACKGROUND OF THE INVENTION

1. Field of the Invention

The present invention generally relates to an electrical connector, and more particularly to an electrical connector having an anti-mismating member.

2. Description of Related Art

Chinese patent issued NO. 202259779 discloses an electrical connector, the electrical connector has an insulating housing, a plurality of conductive terminals secured in the insulating housing and a metallic shell shielding around the insulating housing. The metallic shell surrounds the insulating housing to form an accommodating room. The insulating housing has a base portion and a mating tongue extending forwardly from a front face of the base portion. The insulating housing unitarily forms an anti-mismating portion extending forwardly from the front face of the base portion into the accommodating room in a fixed manner. In use, the anti-mismating portion tends to be destroyed/broken along with many times of wrong insertion due to its inflexibility.

In view of the foregoing, a new style of anti-mismating member is provided in the electrical connector to overcome the drawbacks described aforementioned would be desirable.

### SUMMARY OF THE INVENTION

Accordingly, an object of the present invention is to provide an electrical connector having an anti-mismating member, the anti-mismating member is not easy to be destroyed.

In order to achieve the object set forth, an electrical connector comprises an insulating housing, a plurality of conductive terminals received in the insulating housing and a metallic shell shielding around the insulating housing. The insulating housing has a base portion and a mating tongue extending forwardly from a front face of the base portion. The metallic shell surrounds the mating tongue to form a mating cavity. The conductive terminals have contacting portions exposed on the mating tongue. The metallic shell has an anti-mismating portion extending forwardly from an area adjacent to the base portion into the mating cavity and located on a lateral side of the mating tongue.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector in a first embodiment of the present invention;

FIG. 2 is an exploded perspective view of the electrical connector in FIG. 1;

FIG. 3 is another exploded perspective view of the electrical connector in FIG. 1;

FIG. 4 is a cross-sectional perspective view of the electrical connector in FIG. 1, taken along line 4-4 in FIG. 1;

FIG. 5 is a front view of the electrical connector in FIG. 1;

FIG. 6 is a perspective view of an electrical connector in a second embodiment of the present invention;

FIG. 7 is an exploded perspective view of the electrical connector in FIG. 6;

FIG. 8 is a cross-sectional perspective view of the electrical connector in FIG. 6, taken along line 8-8 in FIG. 6;

FIG. 9 is a front view of the electrical connector in FIG. 6;

FIG. 10 is a perspective view of an electrical connector in a third embodiment of the present invention;

FIG. 11 is an exploded perspective view of the electrical connector in FIG. 10;

FIG. 12 is a cross-sectional perspective view of the electrical connector in FIG. 10, taken along line 12-12 in FIG. 10; and

FIG. 13 is a front view of the electrical connector in FIG. 10.

### DETAILED DESCRIPTION OF THE INVENTION

Reference will now be made in detail to the preferred embodiment of the present invention.

The present invention provides with an electrical connector having an anti-mismating member. The anti-mismating member makes the electrical connector form two different insertion rooms into which two different styles of complementary connectors may mate. Three preferred embodiments of the electrical connector of the present invention will be described in detail hereinafter.

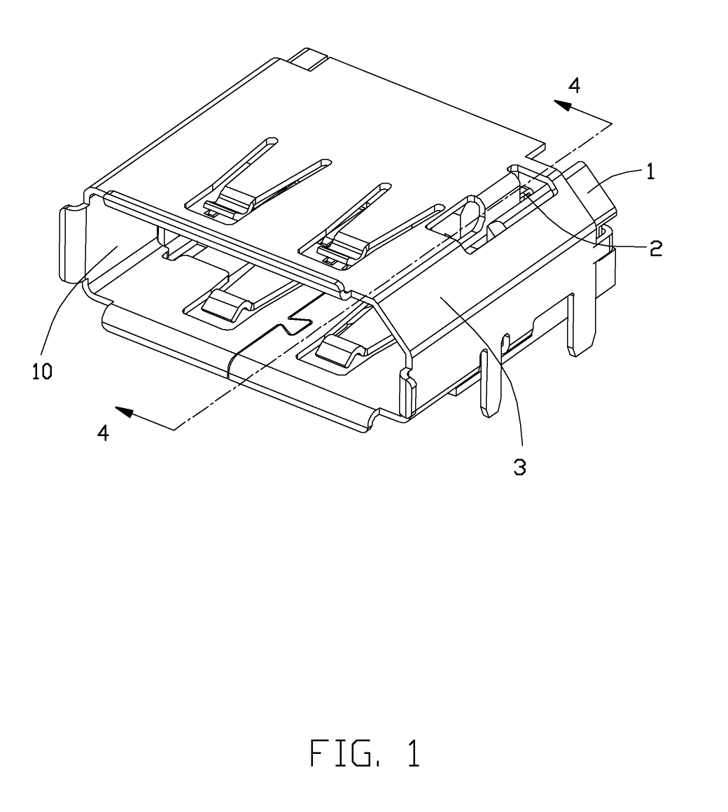

FIG. 1 to FIG. 5 are taken to describe an electrical connector in a first preferred embodiment of the present invention.

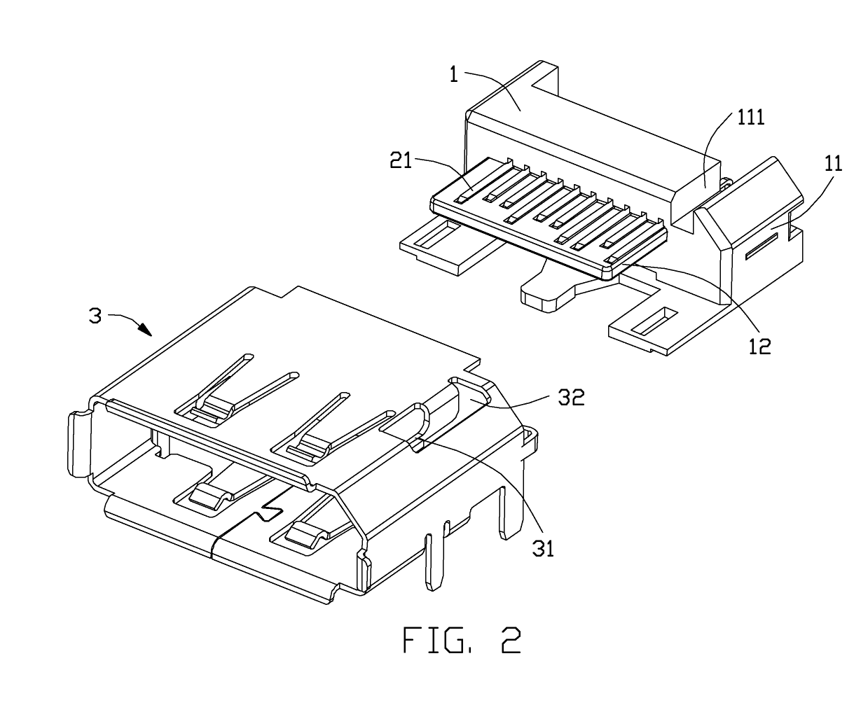

Referring to FIG. 1 and FIG. 2, the electrical connector is able to mate with an HDMI (High-Definition Multimedia Interface) connector or a Displayport connector. The electrical connector has an insulating housing 1, a plurality of conductive terminals 2 received in the insulating housing 1 and a metallic shell 3 shielding around the insulating housing 1. The insulating housing 1 has a base portion 11 and a mating tongue 12 extending forwardly from a front face of the base portion 11. The metallic shell 3 surrounds the mating tongue 12 to form a mating cavity 10. The metallic shell 3 has an anti-mismating portion 31 extending forwardly from an area adjacent to the base portion 11 into the mating cavity 10. The anti-mismating portion 31 is sincerely the anti-mismating member described aforementioned. In the present embodiment, the anti-mismating portion 31 is stamped form the metallic shell 3 and bends downwardly, thereby an opening 32 is formed in the metallic shell 3.

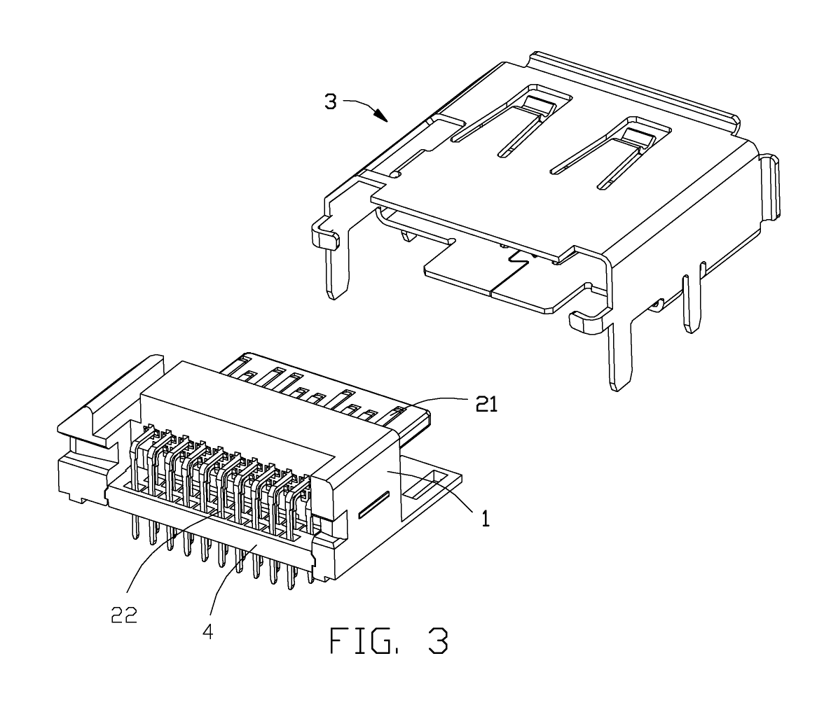

Referring to FIG. 3, the conductive terminals 2 each has a contacting portion 21 exposed on the mating tongue 12 and a soldering portion 22 extending out of the insulating housing 1. The electrical connector further comprises a fixing block 4 disposed behind the insulating housing 1 and fixed on the base portion 11. The fixing block 4 has a plurality of through holes (not labeled) in which the soldering portions 22 are fixed.

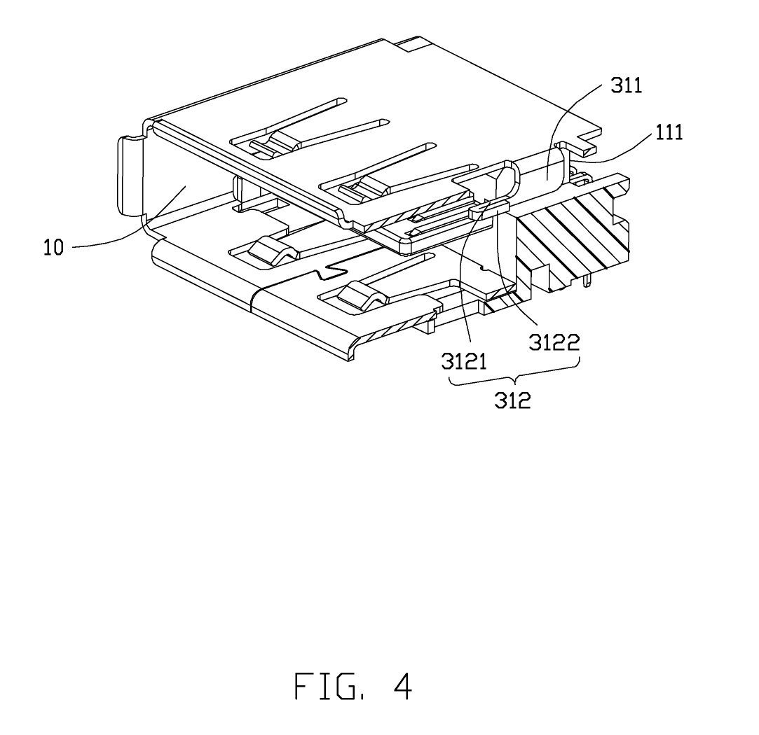

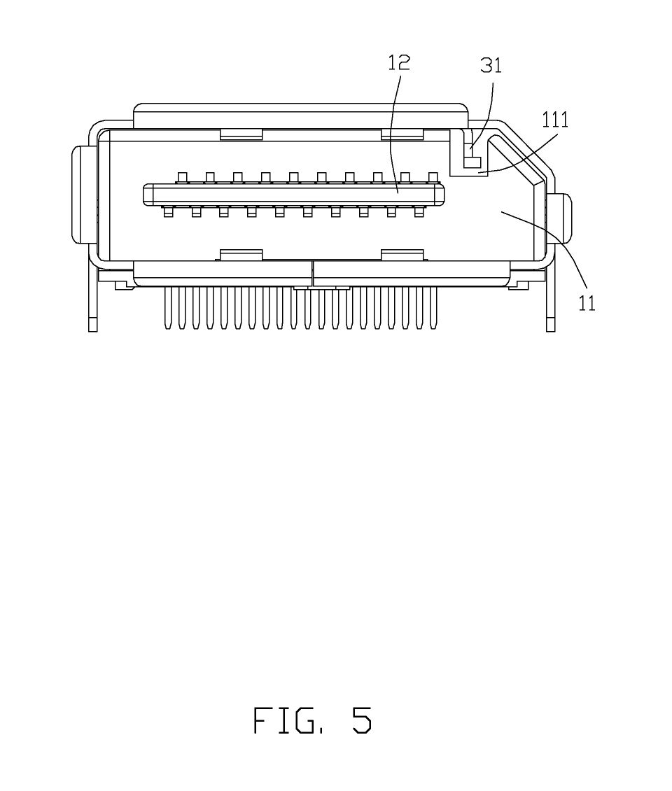

Referring to FIG. 2 and FIG. 4, the base portion 11 has an accommodating room 111 located between a front face and a rear face of the base portion 11. The accommodating room 111 runs upwardly through an upper surface of the base portion 11 and forwardly through the front face of the base portion 11. The anti-mismating portion 31 is received in the accommodating room 111 and further extends into the mating cavity 10. The anti-mismating portion 31 has a protruding portion 312 and a connecting portion 311 connecting the protruding portion 312 with the metallic shell 3 and located in the accommodating room 111. The protruding portion 312 extends forwardly into the mating cavity 10 from the connecting portion 311. In the present invention, the protruding portion 312 has a first segment 3121 and a second segment 3122 bending rearwardly from the first segment 3121. The first and second segments 3121, 3122 abut against each other tightly. The second segment 3122 isn't longer than the first segment 3121 along a mating direction. In other embodiments, of course, the protruding portion 312 may have some different numbers of segments so as to meet different demands. Some other methods are also possible to connect different segments together such as soldering, pasting etc. Combined with FIG. 5, the anti-mismating portion 31 hangs in the accommodating room 111 so as to be movable therein, and is not in touch with the insulating housing 1.

Of course, the connecting portion 311 of the anti-mismating portion 31 may be partly received in the accommodating room 111 or be entirely located in front of the base portion 11 and received in the mating cavity 10 in other embodiments.

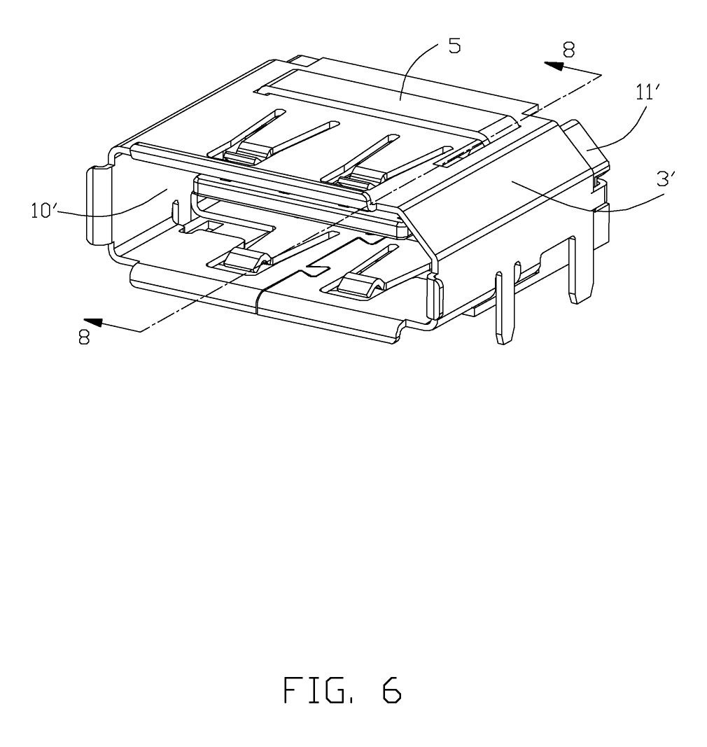

FIG. 6 to FIG. 9 are taken to describe an electrical connector in a second preferred embodiment of the present invention. The structures of the electrical connector in the second preferred embodiment is rough similar to that of the first preferred embodiment. The same structures will be labeled with the same labels and are not described in detail again in the present embodiment.

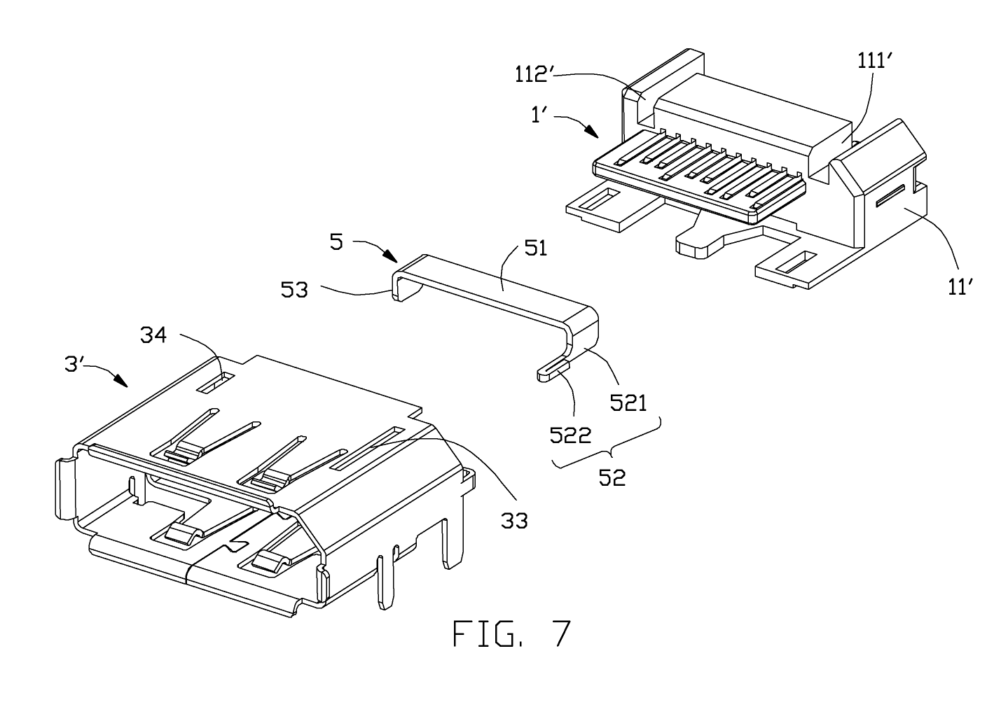

Referring to FIG. 6 and FIG. 7, compared to the first embodiment, the electrical connector in the present embodiment comprises a metallic member or bracket 5 fixed on a metallic shell 3′. The metallic member 5 has a fixing portion 51 fixed on an upper surface of the metallic shell 3′ and an anti-mismating portion 52 extending downwardly from an end of the fixing portion 51. The anti-mismating portion 52 has a connecting portion 521 connecting with the fixing portion 51 and a protruding portion 522 extending forwardly into the mating cavity 10 from the connecting portion 521. The metallic member 5 has a positioning portion 53 extending downwardly from the other end of the fixing portion 51 which is opposite to the anti-mismating portion 52. The positioning portion 53 and the anti-mismating portion 52 are disposed at a same side of the fixing portion 51. It means that the positioning portion 53 and the anti-mismating portion 52 are below the fixing portion 51. The metallic shell 3′ defines a first opening 33 through which the anti-mismating portion 52 runs and a second opening 34 through which the positioning portion 53 runs. A base portion 11′ of the insulating housing 1′ has an accommodating room 111′ receiving the anti-mismating portion 52 and a positioning room 112′ receiving the positioning portion 53.

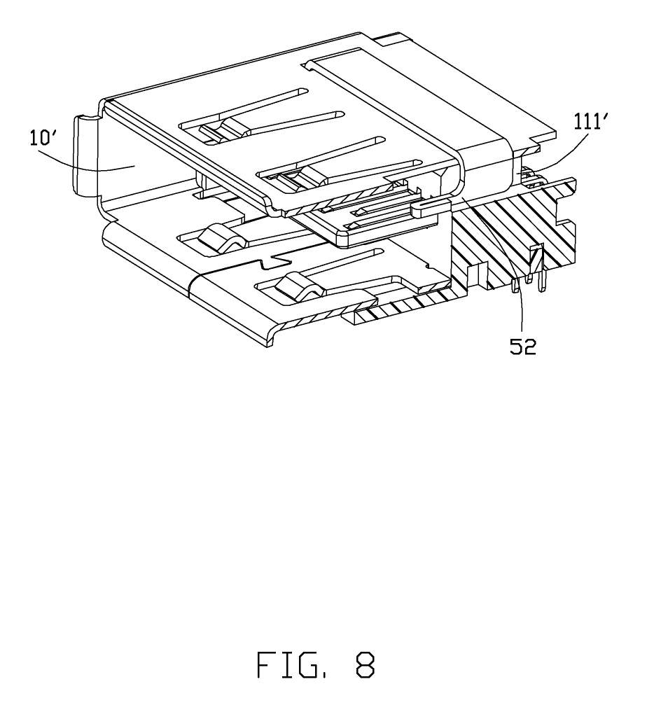

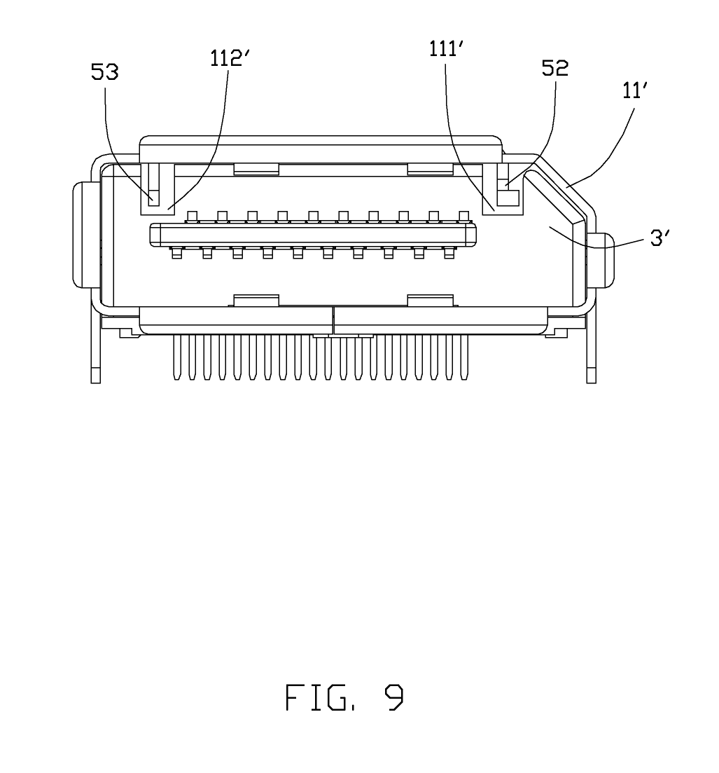

Referring to FIG. 8 and FIG. 9, the anti-mismating portion 52 hangs in the accommodating room 111′ so as to make itself be movable in use. The connecting portion 521 is received in the accommodating room 111′, and the protruding portion 522 extends into the mating cavity 10′. The anti-mismating portion 52 is not in touch with the insulating housing 1′.

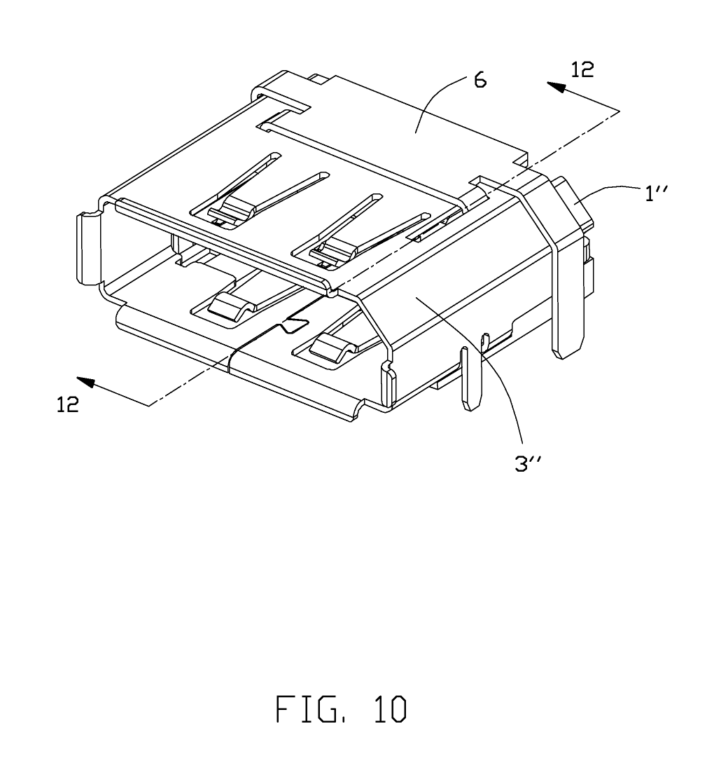

FIG. 10 to FIG. 13 are taken to describe an electrical connector in a third preferred embodiment of the present invention. The structures of the electrical connector in the third preferred embodiment is rough similar to that of the first preferred embodiment. The same structures will be labeled with the same labels and are not described in detail again in the present embodiment.

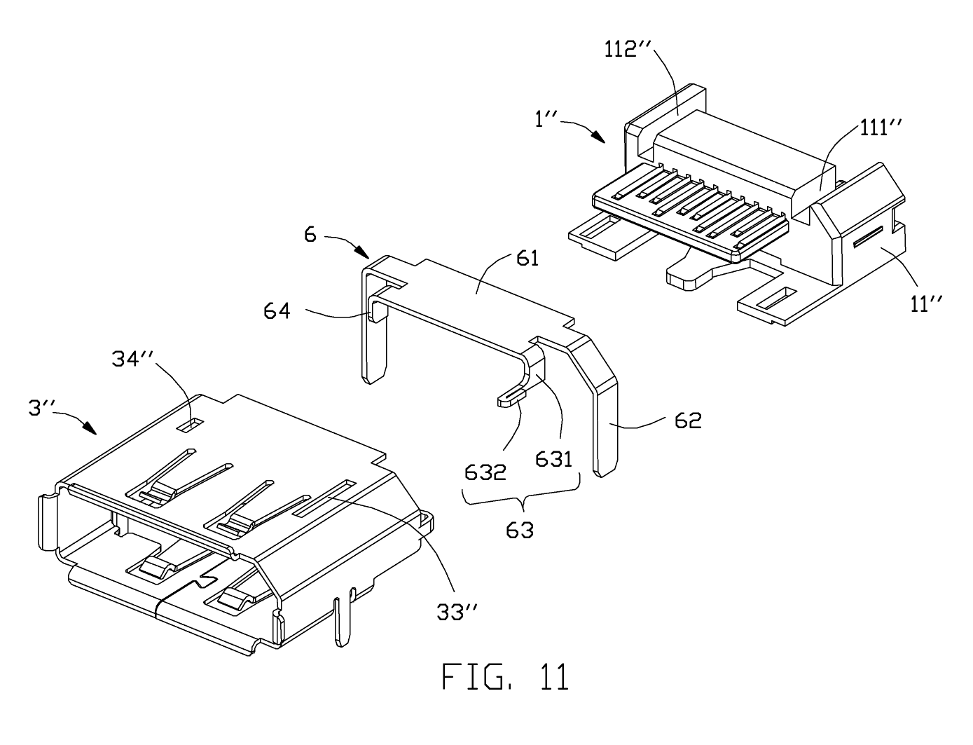

Referring to FIG. 10 and FIG. 11, compared to the first embodiment, the electrical connector in the third embodiment has a retaining member or bracket 6 fixed on the metallic shell 3″ which is used for fixing the electrical connector on a printed circuit board (not labeled). The retaining member 6 has a main body 61, a pair of first retaining legs 62 extending downwardly from the main body 61 and an anti-mismating portion 63 extending downwardly from the main body 61 into the mating cavity 10″. The pair of first retaining legs 62 are separately disposed at two sides of the metallic shell 3″ and downwardly extend out of the insulating housing 1″. The anti-mismating portion 63 has a connecting portion 631 connecting with the main body 61 and a protruding portion 632 extending into the mating cavity 10″ from the connecting portion 631. Furthermore, the retaining member 6 has a positioning portion 64 extending downwardly from the other end of the main body 61 which is opposite to the anti-mismating portion 63. The positioning portion 64 and the anti-mismating portion 63 are disposed at one side of the main body 61.

It means that the positioning portion 64 and the anti-mismating portion 63 are below the main body 61. A metallic shell 3″ defines a first opening 33″ through which the anti-mismating portion 63 runs and a second opening 34″ through which the positioning portion 64 runs. A base portion 11″ of an insulating housing 1″ has an accommodating room 111″ receiving the anti-mismating portion 63 and a positioning room 112″ receiving the positioning portion 64.

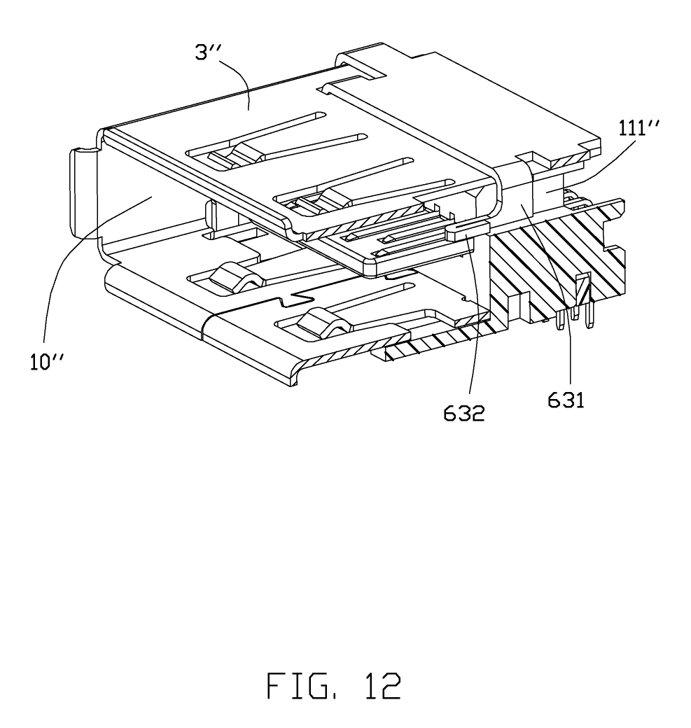

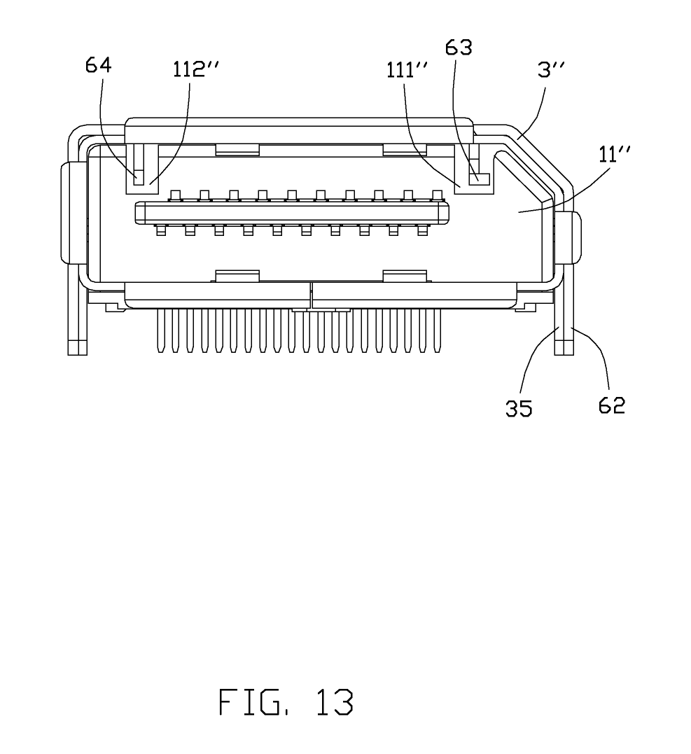

Referring to FIG. 12 and FIG. 13, the anti-mismating portion 63 hangs in the accommodating room 111″ so as to make itself be movable. The connecting portion 631 is received in the accommodating room 111″, and the protruding portion 632 extends into the mating cavity 10″. The anti-mismating portion 63 is not in touch with the insulating housing 1″. The metallic shell 3″ defines a pair of second retaining legs 35 downwardly extending out of the insulating housing 1″. The first and second retaining legs 35, 62 are disposed in a stagger way. The pair of the second retaining legs 35 are in an inner side relative to the pair of the first retaining legs 62.

In a conclusion, the anti-mismating portions 31, 52, 63 are used for preventing wrong insertion of the complementary connectors.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. An electrical connector comprising:
an insulating housing having a base portion and a mating tongue extending forwardly from a front face of the base portion;
a plurality of conductive terminals received in the insulating housing, the conductive terminals having contacting portions exposed on the mating tongue; and
a metallic shell shielding around the insulating housing, the metallic shell surrounding the mating tongue to form a mating cavity;
wherein the metallic shell has an anti-mismating portion extending forwardly from an area adjacent to the base portion into the mating cavity and located on a lateral side of the mating tongue.

2. The electrical connector as claimed in claim 1, wherein the base portion has an accommodating room, the anti-mismating portion is received in the accommodating room and further extends into the mating cavity.

3. The electrical connector as claimed in claim 2, wherein the anti-mismating portion hangs in the accommodating room so as to make itself be movable in the accommodating room.

4. The electrical connector as claimed in claim 3, wherein the anti-mismating portion comprises a connecting portion and a protruding portion, the connecting portion is located in the accommodating room, and the protruding portion extends into the mating cavity from the connecting portion.

5. The electrical connector as claimed in claim 4, wherein the protruding portion has a first resisting portion and a second resisting portion abutting against each other tightly.

6. The electrical connector as claimed in claim 5, wherein the first and second resisting portions are formed by one metal plate, the second resisting portion bends rearwardly from an end of the first resisting portion.

7. The electrical connector as claimed in claim 1, wherein the anti-mismating portion is formed by stamping from the metallic shell and bent downwardly, thereby an opening is formed on the metallic shell.

8. The electrical connector as claimed in claim 1, wherein the metallic shell has a shielding body shielding around the insulating housing and a metallic member fixed on the shielding body, the metallic member has a fixing section fixed on the shielding body, and said anti-mismating portion extends into the mating cavity from an end of the fixing section.

9. The electrical connector as claimed in claim 8, wherein the metallic member has a positioning portion extending downwardly from the other end of the fixing section, the positioning portion and the anti-mismating portion are opposite with each other and located at one side of the fixing section.

10. The electrical connector as claimed in claim 1, wherein the metallic shell has a shielding body shielding around the insulating housing and a retaining member fixed on the shielding body, the retaining member has a main body, and a pair of first retaining legs extending downwardly out of the insulating housing from the main body, and said anti-mismating portion extends into the mating cavity from the main body, the pair of the first retaining legs are located at two sides of the metallic shell.

11. An electrical connector comprising:
an insulating housing having a base portion and a mating portion extending forwardly from the base portion;
a metallic shell shielding around the insulating housing, the metallic shell surrounding the mating portion to form a mating cavity;
a plurality of conductive terminals received in the insulating housing, the conductive terminals each having a contacting section exposed to the mating cavity; and
an anti-mismating member extending into the mating cavity;
wherein the base portion has an accommodating room, and the anti-mismating member is movably received in the accommodating room.

12. The electrical connector as claimed in claim 11, wherein the accommodating room runs upwardly through an upper surface of the base portion and forwardly through a front face of the base portion, the anti-mismating member hangs in the accommodating room and is not in touch with the insulating housing.

13. The electrical connector as claimed in claim 11, wherein the anti-mismating member and the metallic shell are stamped from a same metal plate and connect with each other.

14. The electrical connector as claimed in claim 11, further comprising a metallic member fixed on the metallic shell, and the anti-mismating member extends into the mating cavity from the metallic member.

15. The electrical connector as claimed in claim 11, further comprising a retaining member fixed to the shell for fixing the electrical connector on a printed circuit board, and the anti-mismating member extends into the mating cavity from the retaining member.

16. An electrical connector comprising:
an insulative housing including a base portion and a tongue portion forwardly extending from the base portion in a front-to-back direction;
a metallic shell enclosing the housing and defining a mating cavity in which the tongue portion extends;
a plurality of contacts disposed in the housing with corresponding contacting sections exposed upon the tongue portion in a vertical direction perpendicular to said front-to-back direction; and
a resilient anti-mismating device extending forwardly from a rear side of the mating cavity while being free from said base portion without restraint; wherein
viewed in said front-to-back direction, said anti-mismating device is essentially spaced from a circumferential boundary of said mating cavity and located beside said tongue portion in a transverse direction perpendicular to both said front-to-back direction and said vertical direction.

17. The electrical connector as claimed in claim 16, wherein said base portion forms an accommodating room to receive a rear portion of said anti-mismating device therein without touching.

18. The electrical connector as claimed in claim 17, wherein said anti-mismating device is directly stamped from the shell into the housing.

19. The electrical connector as claimed in claim 17, wherein said anti-mismating device is formed on a metallic bracket which is secured upon the shell.

20. The electrical connector as claimed in claim 19, wherein said bracket includes at least one retaining leg extending downwardly below the mating cavity for mounting to a printed circuit board.
